(19) United States
(12) Patent Application Publication
(10) Pub. No.: US 2024/0289610 A1
(43) Pub. Date: Aug. 29, 2024

(54) HYBRID DATA- AND MODEL-DRIVEN METHOD FOR PREDICTING REMAINING USEFUL LIFE OF MECHANICAL COMPONENT

(71) Applicant: Beijing Institute of Technology, Beijing (CN)

(72) Inventors: Gang WANG, Beijing (CN); Hongjie CAO, Beijing (CN); Jian SUN, Beijing (CN); Minggang GAN, Beijing (CN); Jie CHEN, Beijing (CN)

(73) Assignee: Beijing Institute of Technology, Beijing (CN)

(21) Appl. No.: 18/214,881

(22) Filed: Jun. 27, 2023

(30) Foreign Application Priority Data
Feb. 28, 2023 (CN) 2023101930952

(51) Int. Cl. G06N 3/08; G06F 17/14; G06F 17/16; G06N 3/0442; G06N 3/0464; H03H 17/02

(52) U.S. Cl. CPC G06N 3/08; G06F 17/142; G06F 17/16; G06N 3/0442; G06N 3/0464; H03H 17/0257

(57) ABSTRACT

Disclosed is a hybrid data- and model-driven method for predicting remaining useful life of a mechanical component. The method of the present disclosure uses an extended Kalman filter to calibrate parameters of an exponential random model, automatically learns input embedded position information by means of an adaptive encoding layer of a hybrid driven prediction model, and then models a mapping relation between input data and the remaining useful life by means of a multi-head attention mechanism. The present disclosure retains both accuracy of a model-based method and a generalization capability of a data-driven method in combination with the calibrated exponential random model and a multi-head attention neural network structure, can improve accuracy of predicting the remaining useful life of the mechanical component, and has great significance for use of the hybrid data- and model-driven method in the field of intelligent manufacturing and health management of mechanical apparatuses.

### CROSS REFERENCE TO RELATED APPLICATION

This patent application claims the benefit and priority of Chinese Patent Application No. 2023101930952, filed with the China National Intellectual Property Administration on Feb. 28, 2023, the disclosure of which is incorporated by reference herein in its entirety as part of the present application.

### TECHNICAL FIELD

The present disclosure relates to the technical field of intelligent manufacturing and health management of apparatuses, and in particular to a hybrid data- and model-driven method for predicting remaining useful life of a mechanical component.

### BACKGROUND

In the domain of prognostics and health management of a mechanical component, a future degradation process and remaining useful life (RUL) of a system are estimated on the basis of state monitoring data. However, the degradation process of the mechanical component is usually accompanied with a wide range of uncertainties. In other words, presumable degradation trajectories vary in different devices, and degradation processes vary under different operation conditions and environment conditions. For example, in the case of a rolling bearing, a degradation process will be variable, depending on a type, an operating speed and load, and a type of failure of the bearing. As a result, the degradation process of the bearing will be unpredictable. In view of that, it is necessary to study a method for predicting useful life with high prediction accuracy and a slight influence from an uncertainty. Currently, a method for predicting RUL is mainly divided into two types, i.e., a data-driven method and a model-driven method.

On one hand, the traditional model-based method for predicting RUL builds a model for the degradation process of the system way of a mathematical derivation or on the basis of fault domain knowledge, such as a Paris law of crack extension, and then identifies and calibrates model parameters by means of statistical signal processing techniques such as Kalman filter, extended Kalman filter (EKF) and particle filter, so as to further predict the RUL. However, since it is difficult to obtain degradation and fault mechanisms of different systems in practical applications, using the model-based method is presumably difficult. Despite the difficulty, physical understanding in the model-based method will enhance interpretability of prediction studies and improve accuracy of prediction.

On the other hand, the data-driven method combines state monitoring data with a machine learning technique to train a prediction model. Such a trained model can be used for predicting the RUL. Currently, emergence of large-scale sensor data and system health monitoring data has fueled research on a neural network and a deep learning method. For example, network models such as a convolutional neural network, a recurrent neural network, a long short-term memory (LSTM) network and a transformer have been used in the domain of useful life prediction. The data-driven method has a vast number of advantages. For example, the data-driven method can directly model a complex relation between the degradation process and historical observation data without using sizeable domain knowledge, which can reduce use cost; and a learning based artificial intelligence method can reduce a model error considerably as well as improve accuracy of model prediction. However, the data-driven method is far from flawless. For example, absence of physical understanding of the degradation process leads to lack of interpretability of a data-driven model; and presence of a measurement error and noise in original sensor data leads to poor model prediction accuracy.

### SUMMARY

Aiming at the problem provided in the background above, the present disclosure provides a hybrid data- and model-driven method for predicting remaining useful life of a mechanical component, so as to retain both a generalization capability of a data-driven method and a fidelity of a model-driven method, thereby improving accuracy of predicting the remaining useful life of the mechanical component.

To achieve the above objective, the present disclosure provides the following technical solutions.

In one aspect, a hybrid data- and model-driven method for predicting remaining useful life of a mechanical component is provided, including:
using an exponential random model to model a degradation process of the mechanical component and establish a system state space equation;
estimating, on the basis of the system state space equation, parameters of the exponential random model by means of an extended Kalman filter, to obtain an optimal state estimate;
obtaining state monitoring data in a degradation stage of the mechanical component on the basis of first predicting time, and using fast Fourier transform (FFT) to obtain frequency domain data corresponding to the state monitoring data in the degradation stage;
constructing a neural network training data set of all mechanical components according to the optimal state estimate and the frequency domain data;
building a hybrid driven prediction model including a fully connected layer, a one-dimensional convolutional long short-term memory network adaptive encoding layer, a multi-head attention mechanism module, a feedforward module and a fully connected regression layer;
using the neural network training data set to train and test the hybrid driven prediction model, to obtain a trained hybrid driven prediction model; and
using the trained hybrid driven prediction model to predict the remaining useful life of the mechanical component.

Optionally, the using an exponential random model to model a degradation process of the mechanical component and establish a system state space equation specifically includes:
using the exponential random model

$${a}_{k} {e}^{{b}_{k}}$$

to model the degradation process of the mechanical component, aₖ, bₖ being a parameter related to a health state of the mechanical component in the degradation process; and
building the system state space equation

$$\{ \begin{matrix}{x}_{k} = f ( {x}_{k - 1} , {u}_{k - 1} ) + {w}_{k - 1} \\ {z}_{k} = h ( {x}_{k} ) + {v}_{k}\end{matrix}$$

on the basis of the exponential random model

$${a}_{k} {e}^{{b}_{k}} ,$$

a state vector at a moment k being

$${x}_{k} = {[ \begin{matrix}{a}_{k} {e}^{{b}_{k}} & {a}_{k} & {b}_{k}\end{matrix} ]}^{\cdot } ,$$

ƒ and h being nonlinear functions, xₖ₋₁ being a state vector at a moment k−1, uₖ₋₁ being a system input at the moment k−1, wₖ₋₁ being a random zero mean error at the moment k−1, zₖ being a measured value at the moment k, and vₖ being a measurement error at the moment k.

Optionally, the estimating, on the basis of the system state space equation, parameters of the exponential random model by means of an extended Kalman filter, to obtain an optimal state estimate specifically includes:
locally linearizing, on the basis of the system state space equation, the nonlinear functions ƒₖ and hₖ at the moment k about a state prior estimate \hat{x}ₖ, to obtain corresponding Jacobian matrices Fₖ and Hₖ;
building a prediction and update equation of an extended Kalman filter according to the Jacobian matrices Fₖ and Hₖ; and
alternately executing, on the basis of the prediction and update equation, a prediction and update process of the extended Kalman filter to continuously update a predicted state vector, so as to obtain the optimal state estimate.

Optionally, the obtaining state monitoring data in a degradation stage of the mechanical component on the basis of first predicting time, and using fast Fourier transform (FFT) to obtain frequency domain data corresponding to the state monitoring data in the degradation stage specifically includes:
determining the first predicting time on the basis of original state monitoring data of the mechanical component collected by a sensor;
extracting the state monitoring data in the degradation stage of the mechanical component on the basis of the first predicting time; and
using the FFT to extract frequency domain information of the state monitoring data in the degradation stage, to obtain the frequency domain data in the degradation stage

Optionally, the constructing a neural network training data set of all mechanical components according to the optimal state estimate and the frequency domain data specifically includes:
constructing the neural network training data set

$${D}^{( i )} = {\{ ( {\tilde{f}}_{k}^{( i )} , {x}_{k}^{( i )} , {\tilde{y}}_{k}^{( i )} ) \}}_{k = 0}^{{n}_{i} - 3 - {t}_{i}} , i = 1 , … , Q$$

of all the mechanical components according to the optimal state estimate {xₖ⁽ⁱ⁾}ₖ₌₀ⁿ^{ᵢ}^{-3-t}^{ᵢ} and the frequency domain data {\tilde{f}ₖ⁽ⁱ⁾}ₖ₌₀ⁿ^{ᵢ}^{-3-t}^{ᵢ} in the degradation stage of the mechanical component, a moment tᵢ being the first predicting time, nᵢ being a length of a variance feature sequence, being the number [symbol] of the mechanical components i, and \tilde{y}ₖ⁽ⁱ⁾ being the remaining useful life of the mechanical component i at the moment k.

In another aspect, a hybrid data- and model-driven system for predicting remaining useful life of a mechanical component is provided, including:
a degradation model building module for using an exponential random model to model a degradation process of the mechanical component and establish a system state space equation;
an extended Kalman filter module for estimating, on the basis of the system state space equation, parameters of the exponential random model by means of an extended Kalman filter, to obtain an optimal state estimate;
an FFT feature extraction module for obtaining state monitoring data in a degradation stage of the mechanical component on the basis of first predicting time, and using an FFT to obtain frequency domain data corresponding to the state monitoring data in the degradation stage;
a training data set construction module for constructing a neural network training data set of all mechanical components according to the optimal state estimate and the frequency domain data;
a hybrid driven prediction model building module for building a hybrid driven prediction model including a fully connected layer, a one-dimensional convolutional long short-term memory network adaptive encoding layer, a multi-head attention mechanism module, a feedforward module and a fully connected regression layer;
a hybrid driven prediction model training module for using the neural network training data set to train and test the hybrid driven prediction model, to obtain a trained hybrid driven prediction model; and
a remaining useful life prediction module for using the trained hybrid driven prediction model to predict the remaining useful life of the mechanical component.

In still another aspect, an electronic device is provided, including a memory, a processor and a computer program stored in the memory and runnable on the processor, where the processor implements the above-described hybrid data- and model-driven method for predicting remaining useful life of a mechanical component when executing the computer program.

In yet another aspect, a non-transient computer-readable storage medium storing a computer program is provided, where the computer program implements the above-described hybrid data- and model-driven method for predicting remaining useful life of a mechanical component when executed.

According to the embodiments of the present disclosure, the present disclosure has the following technical effects:

The hybrid data- and model-driven method for predicting remaining useful life of a mechanical component according to the present disclosure retains both accuracy of a model-based method and a generalization capability of a data-driven method, uses an extended Kalman filter to calibrate parameters of an exponential random model, automatically learns input embedded position information by means of a one-dimensional convolutional long short-term memory network adaptive encoding layer, and then models a mapping relation between input data and the remaining useful life by means of a multi-head attention mechanism, which improves accuracy of predicting the remaining useful life, and has great significance for use of the hybrid data- and model-driven method in the field of prediction and health management.

### BRIEF DESCRIPTION OF THE DRAWINGS

In order to more clearly illustrate technical solutions in the embodiments of the present disclosure or in the prior art, a brief introduction to the accompanying drawings required for the embodiments will be provided below. Obviously, the accompanying drawings in the following description are only some embodiments of the present disclosure, and those of ordinary skill in the art would also be able to derive other accompanying drawings from these accompanying drawings without making creative efforts.

FIG. 1 is a flowchart of a hybrid data- and model-driven method for predicting remaining useful life of a mechanical component according to the present disclosure;

FIG. 2 is a schematic diagram of a network structure of a hybrid driven prediction model built in the method of the present disclosure;

FIGS. 3A-D are schematic diagrams of an actual operation effect of the method of the present disclosure on an FEMTO bearing data set;

FIG. 4A is a schematic diagram of a hybrid data- and model-driven system for predicting RUL of a mechanical component according to the present disclosure;

FIG. 4B is an architecture of computing device for implementing the system shown in FIG. 4A; and

FIG. 5 is a specific schematic diagram of the hybrid driven prediction model building module shown in FIG. 4A.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the described embodiments are merely some embodiments rather than all embodiments of the present disclosure. On the basis of the embodiments in the present disclosure, all other embodiments derived by those of ordinary skill in the art without making creative efforts shall fall within the scope of protection of the present disclosure.

The objective of the present disclosure is to provide a hybrid data- and model-driven method for predicting remaining useful life (RUL) of a mechanical component, which may introduce relevant domain knowledge through a model-driven method, to calibrate original input data, and further utilizes a data-based method to model a complex relation between the input data and a degradation process, so as to retain both a generalization capability of the data-driven method and a fidelity of the model-driven method, thereby improving accuracy of predicting the RUL of the mechanical component.

To make the above objectives, features, and advantages of the present disclosure clearer and more comprehensible, the present disclosure will be further described in detail below with reference to the accompanying drawings and the specific implementations.

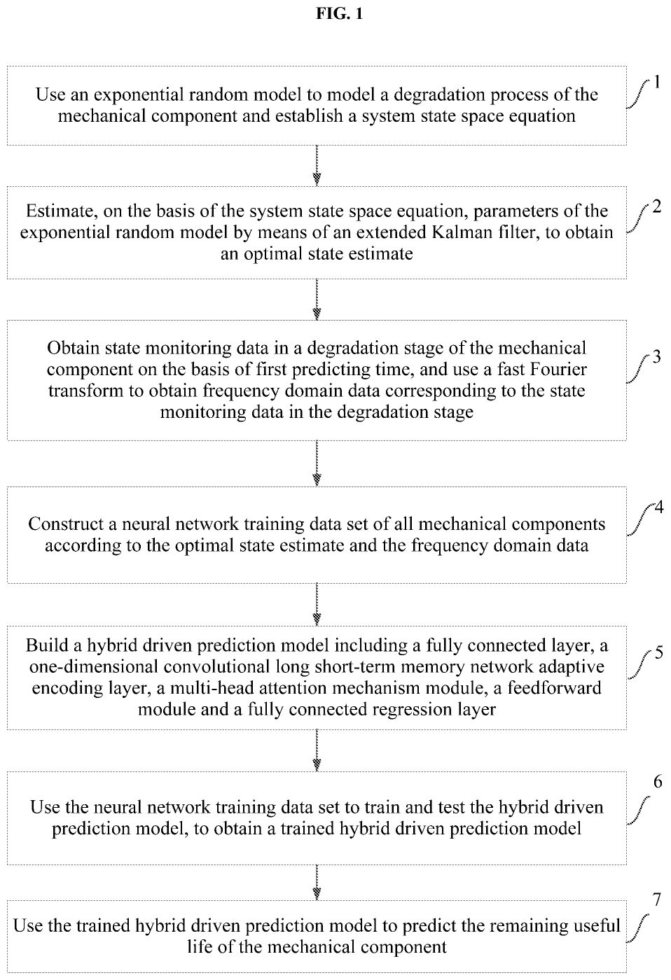

With reference to FIG. 1, a hybrid data- and model-driven method for predicting RUL of a mechanical component includes:
step 1, use an exponential random model to model a degradation process of the mechanical component and establish a system state space equation.

In the present disclosure, a sequence signal measured by a sensor is represented as {sₖ⁽ⁱ⁾}ₖ₌₀^{m}^{ᵢ}⁻¹, and a vector sₜ⁽ⁱ⁾∈ [symbol] is a vector including a sensor signal from a moment k to a moment k+p. i=1, . . . , [symbol] represents the sensor signal being sampled from [symbol] different mechanical components of the same type, such as bearings. mᵢ represents useful life of a component i. Variance features of the sequence signal {sₖ⁽ⁱ⁾}ₖ₌₀^{m}^{ᵢ}⁻¹ are extracted to obtain a variance feature sequence {varₖ⁽ⁱ⁾}ₜ₌₀ⁿ^{ᵢ}⁻¹ represents a variance of the sensor signal from the moment k to the moment k+p of the component i, and nᵢ=mᵢ/p is a length of the variance feature sequence of the component i.

The method of the present disclosure considers using the exponential random model

$${a}_{k} {e}^{{b}_{k}}$$

to fit a variance feature curve. That is, an exponential model is used to represent the degradation process of the mechanical component as a degradation model of the mechanical component. Unknown parameters aₖ, bₖ of the model are parameters related to a health state of the component in the degradation process. The parameters of the exponential random model are estimated by means of an extended Kalman filter (EKF). Generally, a process of estimating the parameters of the model requires establishment of the system state space equation, which is generally in a form of:

$$\{ \begin{matrix}{x}_{k} = f ( {x}_{k - 1} , {u}_{k - 1} ) + {w}_{k - 1} \\ {z}_{k} = h ( {x}_{k} ) + {v}_{k}\end{matrix} \qquad ( 1 )$$

A state vector

$${x}_{k} = {[ \begin{matrix}{a}_{k} {e}^{{b}_{k}} & {a}_{k} & {b}_{k}\end{matrix} ]}^{\cdot }$$

at the moment k consists of an exponential function

$${a}_{k} {e}^{{b}_{k}}$$

and the parameters aₖ and bₖ of the exponential model. ƒ and h are nonlinear functions. uₖ is a system input at the moment k, which is 0 in the method. w_{K} is a random zero mean error, of which an error covariance matrix is Qₖ. zₖ is a measured value, and includes a variance feature Varₖ⁽ⁱ⁾ of the sensor signal of the mechanical component i. vₖ is a measurement error, of which an error covariance matrix is Rₖ.

Step 2, estimate, on the basis of the system state space equation, parameters of the exponential random model by means of an EKF, to obtain an optimal state estimate;

In step 2, the parameters of the exponential random model are calibrated by means of the EKF. Step 2 specifically includes:
step 2.1, locally linearize, on the basis of the system state space equation, the nonlinear functions ƒₖ and hₖ at the moment k about a state prior estimate \hat{x}ₖ, to obtain corresponding Jacobian matrices Fₖ and Hₖ.

In the EKF, the nonlinear functions ƒ and h in the system state space equation (1) require to generate matrices F and H respectively by computing the corresponding Jacobian matrices, and are locally linearized at an estimated state.

In an iteration process of Kalman filter, the parameters aₖ and bₖ of the exponential model are constantly changed, and therefore the nonlinear function ƒₖ consisting of the parameters aₖ and bₖ is also changed at different moments k. The nonlinear functions ƒₖ and hₖ at the moment k are locally linearized about the state prior estimate \hat{x}ₖ, to obtain the corresponding Jacobian matrices Fₖ and Hₖ:

$${F}_{k} = \frac{\partial f}{\partial x} {\vert}_{{\hat{x}}_{k}} = [ \begin{matrix}0 & {e}^{{b}_{k} k} & {ka}_{k} {e}^{{b}_{k} k} \\ 0 & 1 & 0 \\ 0 & 0 & 1\end{matrix} ] \qquad ( 2 )$$

$${H}_{k} = \frac{\partial h}{\partial x} {\vert}_{{\hat{x}}_{k}} = [ \begin{matrix}1 & 0 & 0\end{matrix} ] \qquad ( 3 )$$

The state prior estimate \hat{x}ₖ refers to an updated state value obtained through Kalman filter, which is a posteriori estimate of a state xₖ.

After the Jacobian matrices Fₖ and Hₖ are obtained, a nonlinear system in the method may be approximated as a linear system, such that a prediction and update process of a Kalman filter may be carried out to estimate the state xₖ.

Step 2.2, build a prediction and update equation of the EKF according to the Jacobian matrices Fₖ and Hₖ.

In the method of the present disclosure, the prediction and update equation of the EKF established according to the Jacobian matrices Fₖ and Hₖ is as follows:

$$\{ \begin{matrix}{\hat{x}}_{k} = {F}_{k - 1} {x}_{k - 1} + {w}_{k - 1} \\ {z}_{k} = {x}_{k} ( 1 ) + {v}_{k}\end{matrix} \qquad ( 4 )$$

xₖ (1)=Hₖxₖ is a first item of the state xₖ.

Step 2.3, alternately execute, on the basis of the prediction and update equation, a prediction and update process of the EKF to continuously update a predicted state vector, so as to obtain the optimal state estimate.

On the basis of the degradation model (i.e. exponential random model

$${a}_{k} {e}^{{b}_{k}} )$$

and the state space equation (1) provided in step 1, the EKF is used to estimate the parameters of the degradation model. The state vector x₀ and a covariance matrix P₀ are initialized, and prediction is carried out on the basis of the prediction and update equation (4) provided in step 2.2. A prediction process is shown in equation (5):

$$\{ \begin{matrix}{\hat{x}}_{k} = f ( {\hat{x}}_{k - 1} ) + {w}_{k - 1} \\ {M}_{k} = {F}_{k - 1} {P}_{k - 1} {F}_{k - 1} + {Q}_{k - 1}\end{matrix} \qquad ( 5 )$$

Pₖ₋₁ represents an error covariance matrix at a moment k−1. Qₖ₋₁ represents an error covariance matrix of a process error wₖ₋₁ at the moment k−1. Mₖ represents a priori estimate covariance matrix at the moment k.

Next, equation (6) uses a Kalman gain Kₖ to update a predicted state vector \hat{x}ₖ and a covariance matrix Pₖ:

$$\{ \begin{matrix}{K}_{k} = {M}_{k} {{H}_{k}^{\cdot } ( {H}_{k} {M}_{k} {H}_{k}^{\cdot } + {R}_{k} )}^{- 1} \\ {\hat{x}}_{k} ← {\hat{x}}_{k} + {K}_{k} ( {z}_{k} - {H}_{k} {\hat{x}}_{k} ) \\ {P}_{k} = ( 1 - {K}_{k} {H}_{k} ) {M}_{k}\end{matrix} \qquad ( 6 )$$

zₖ is a measured value, and is a variance feature varₖ of the sensor signal. Prediction and update steps are continuously and circularly executed until a variable k reaches the maximum number of cycles, i.e., a length n of a variance feature of the sensor signal. Through the EKF, an optimally estimated state variable time sequence {xₖ⁽ⁱ⁾}ₖ₌₀ⁿ^{ᵢ}⁻¹, which is abbreviated as the optimal state estimate, may be obtained. The time sequence includes a change trend of the sensor signal in the degradation process described by a model-based method. The information will be fused with original sensor signal data {sₖ⁽ⁱ⁾}ₖ₌₀^{m}^{ᵢ}⁻¹ in subsequent steps, and finally is input into a hybrid driven prediction model to predict the RUL. The part of data improves interpretability and accuracy of the method for predicting RUL, and a specific fusion manner will be introduced in the following steps.

Step 3, obtain state monitoring data in a degradation stage of the mechanical component on the basis of first predicting time (FPT), and use fast Fourier transform (FFT) to obtain frequency domain data corresponding to the state monitoring data of the degradation stage.

In step 3, the FPT is determined on the basis of the collected state monitoring data, and kurtosis of the signal is used as an indicator. When the kurtosis exceeds an interval 3σ, it indicates that degradation begins; the FFT is used to preliminarily feature and extract a target and provide time domain information and frequency domain information; and a percentage is used to represent a label of the RUL. Step 3 specifically includes:
step 3.1, determine the FPT on the basis of original state monitoring data of the mechanical component collected by a sensor.

In step 2, the optimal state estimate {xₜ⁽ⁱ⁾}ₜ₌₀ⁿ^{ᵢ}⁻¹ is obtained by estimating the parameters of the exponential model. In order to achieve hybrid drive with a data model, it is further necessary to pre-extract features of original sensor time sequence signal data {sₖ⁽ⁱ⁾}ₖ₌₀^{m}^{ᵢ}⁻¹. {sₖ⁽ⁱ⁾}ₖ₌₀^{m}^{ᵢ}⁻¹ is the original state monitoring data of the mechanical component collected by the sensor, is usually vibration signal data in the horizontal direction or vertical direction, and is collected by an accelerometer.

Firstly, the FPT is determined. The FPT divides a whole life cycle of the mechanical component into a health stage and a degradation stage. Only data from the degradation stage is used for predicting the RUL, which may reduce an influence of other irrelevant data apart from degradation data, and improve accuracy of prediction.

The kurtosis of the sensor signal {sₖ⁽ⁱ⁾}ₖ₌₀^{m}^{ᵢ}⁻¹ is extracted on the basis of equation (7), to determine the FPT:

$$\vert {kurtosis}_{k + j} - u \vert > 3 {σ}_{s} j = 0 , 1 , 2 \qquad ( 7 )$$

kurtosisₖ₊ⱼ represents the kurtosis at the moment k+j, and u and σₛ represent a mean and a standard deviation of the kurtosis respectively. Equation (7) indicates that when the kurtosis of the sensor signal {sₖ⁽ⁱ⁾}ₖ₌₀^{m}^{ᵢ}^{-1-t}^{ᵢ} exceeds 3 times of the standard deviation σₛ for three consecutive times tᵢ, tᵢ₊₁, tᵢ₊₂ from a moment tᵢ, the moment tᵢ is the FPT, and the sensor data {sₖ⁽ⁱ⁾}ₖ₌₀^{m}^{ᵢ}^{-1-t}^{ᵢ} from the moment tᵢ is used for subsequent prediction.

Step 3.2, extract the state monitoring data of the degradation stage of the mechanical component on the basis of the FPT.

The sensor data {sₖ⁽ⁱ⁾}ₖ₌₀^{m}^{ᵢ}^{-1-t}^{ᵢ} extracted from the moment tᵢ is the state monitoring data of the degradation stage of the mechanical component.

Step 3.3, use the FFT to extract frequency domain information of the state monitoring data of the degradation stage, to obtain the frequency domain data in the degradation stage

After the FPT, the sensor data {sₖ⁽ⁱ⁾}ₖ₌₀^{m}^{ᵢ}^{-1-t}^{ᵢ} of the degradation stage is obtained, and then the FFT is used to extract the frequency domain information of the time sequence sensor signal {sₖ⁽ⁱ⁾}ₖ₌₀^{m}^{ᵢ}^{-1-t}^{ᵢ}. After the FFT, the frequency domain data {fₖ⁽ⁱ⁾}ₖ₌₀ⁿ^{ᵢ}^{-1-t}^{ᵢ} is obtained. fₖ⁽ⁱ⁾∈ [symbol] represents a frequency domain vector of a dimension being q at the moment k of the component i.

In order to subsequently train a long short-term memory network, \tilde{f}ₖ⁽ⁱ⁾=[fₖ⁽ⁱ⁾, fₖ₊₁⁽ⁱ⁾, fₖ₊₂⁽ⁱ⁾]^{•}∈ [symbol] , k=0, . . . , nᵢ−3−tᵢ is set. That is, a time step used for [symbol] the long short-term memory (LSTM) network is 3. The label of the RUL corresponding to each moment k of the frequency domain data {\tilde{f}ₖ⁽ⁱ⁾}ₖ₌₀ⁿ^{ᵢ}^{-3-t}^{ᵢ}, is determined by means of the following equation (8):

$${\tilde{y}}_{k}^{( i )} = 1 - \frac{k}{{n}_{i} - 3 - {t}_{i}} \qquad ( 8 )$$

\tilde{y}ₖ⁽ⁱ⁾ represents a RUL value at the moment k of the component i, and is a ratio between 0 and 1, and nᵢ−3−tᵢ represents a total length of time of the degradation stage.

Step 4, construct a neural network training data set of all mechanical components according to the optimal state estimate and the frequency domain data.

By means of the FPT and the FFT, in step 3, the frequency domain data {fₖ⁽ⁱ⁾}ₖ₌₀ⁿ^{ᵢ}^{-3-t}^{ᵢ}, of the degradation stage is obtained. The frequency domain data and the optimal state estimate {xₖ⁽ⁱ⁾}ₖ₌₀ⁿ^{ᵢ}^{-3-t}^{ᵢ} of the degradation stage obtained by means of the degradation model jointly form

the neural network training data set

$${D}^{( i )} = {\{ ( {\tilde{f}}_{k}^{( i )} , {x}_{k}^{( i )} , {\tilde{y}}_{k}^{( i )} ) \}}_{k = 0}^{n , - 3 - t} , i = 1 , … , Q$$

of all the mechanical components. The data set is used for subsequently training the hybrid driven prediction model.

Step 5, build a hybrid driven prediction model including a fully connected layer 205A, a one-dimensional convolutional long short-term memory (CLSTM) network adaptive encoding layer 205B, a multi-head attention mechanism module 205C, a feedforward module 205D and a fully connected regression layer 205E.

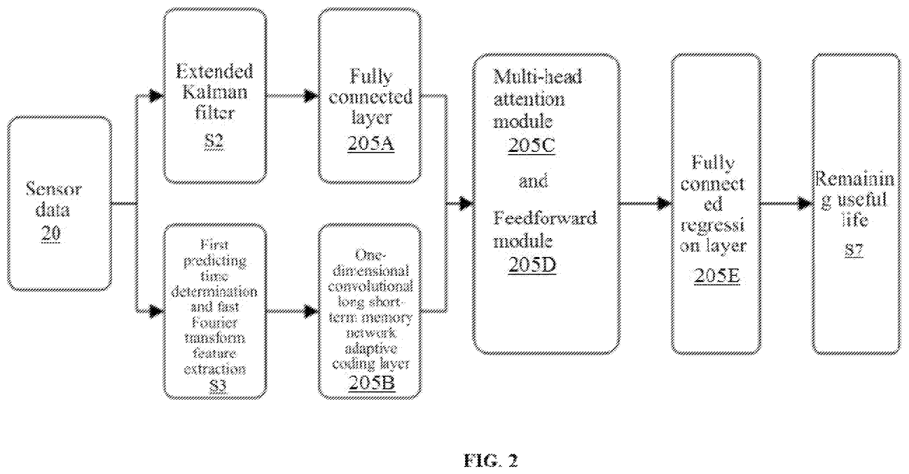

With reference to FIG. 2, a hybrid driven prediction model built by the present disclosure includes a fully connected layer 205A, a one-dimensional CLSTM network adaptive encoding layer 205B, a multi-head attention mechanism module 205C, a feedforward module 205D and a fully connected regression layer 205E. In a network structure of a hybrid driven prediction model established by the present disclosure, outputs of the fully connected layer 205A and the one-dimensional CLSTM network adaptive encoding layer 205B are both used as inputs of the multi-head attention mechanism module 205C. The multi-head attention mechanism module 205C is connected to the feedforward module 205D in a residual manner, and an output of the feedforward module 205D is also connected to the fully connected regression layer 205E in a residual manner.

The hybrid driven prediction model uses a one-dimensional convolutional layer to extract shallow features, and then inputs the shallow features into a CLSTM network to adaptively code an input. A state vector

$${x}_{k} = [ {a}_{k} {e}^{{b}_{k}} {a}_{k} {b}_{k} ] .$$

learned in step 2 is mapped by means of the fully connected layer 205A and is used as an expression token to be input into the multi-head attention mechanism module 205C and the feedforward module 205D together with the adaptively encoded shallow features. Tasks of category related information are mined from an input embedded sequence. The output of the feedforward module 205D is input to the fully connected regression layer 205E to embed and map fused features to the corresponding RUL. Since the RUL is represented in a form of a percentage in the present disclosure, a RUL mapping layer consisting of the single fully connected layer and a Sigmoid activation function is used to achieve the above goal.

Specifically, after step 4 is executed, a neural network training data set

$${D}^{( i )} = {\{ ( {\tilde{f}}_{k}^{( i )} , {x}_{k}^{( i )} , {\tilde{y}}_{k}^{( i )} ) \}}_{k = 0}^{{n}_{i} - 3 - {t}_{i}} , i = 1 , … , Q$$

is obtained. The data set of a component l is selected as a test set

$${\{ {\tilde{f}}_{k}^{( l )} , {x}_{k}^{( l )} , {\tilde{y}}_{k}^{( l )} \}}_{k = 0}^{{n}_{l} - 3 - {t}_{l}} ,$$

and other [symbol] −1 data sets are selected as a training set

$${D}^{( i )} = {\{ {\tilde{f}}_{k}^{( i )} , {x}_{k}^{( i )} , {\tilde{y}}_{k}^{( i )} \}}_{k = 0}^{{n}_{i} - 3 - {t}_{i}} , i = 1 , … , l - 1 , l + 1 , … , Q .$$

At the beginning of training, a batch of data {F, X, Y} is randomly selected. is the quantity of each batch of data, F=[\tilde{f}1, . . . , \tilde{f}_{batch}]^{•}∈ [symbol] , X=[x₁, . . . , x_{batch}]^{•}∈ [symbol] and Y=[\tilde{y}₁, . . . , \tilde{y}_{batch}]^{•}∈ [symbol] . batch is the number of each batch of data. Firstly, x is mapped as \tilde{X}=[\tilde{x}1, . . . , \tilde{x}_{batch}]^{•}∈ [symbol] by means of the fully connected layer. The fully connected layer network may be represented as:

$$\tilde{x} = Sigmoid ( {W}_{x} x + {b}_{x} ) \qquad ( 9 )$$

Wₓ ∈ [symbol] and bₓ∈ [symbol] are network parameters, and r represents the number of neurons in an output layer of the fully connected layer network, i.e., a dimension of the output layer of the fully connected layer.

Then, a tensor F=[\tilde{f}1, . . . , \tilde{f}_{batch}]^{•}∈ [symbol] , is input into the one-dimensional CLSTM network adaptive encoding layer 205B. Data F is subjected to adaptive positional encoding by means of the CLSTM, which aims to add position information to the input data. As an extension of an LSTM network, a CLSTM uses a structure similar to the LSTM, and replaces a fully connected operation in the LSTM with a convolution operation. A relevant equation of the CLSTM is as follows:

$$\begin{matrix}{i}_{k} = σ ( {W}_{fi} * {\tilde{f}}_{k} + {W}_{h i} {h}_{k - 1} + {b}_{i} ) \\ {e}_{k} = σ ( {W}_{fe} * {\tilde{f}}_{k} + {W}_{h e} {h}_{k - 1} + {b}_{e} ) \\ {o}_{k} = σ ( {W}_{fo} * {\tilde{f}}_{k} + {W}_{h o} {h}_{k - 1} + {b}_{o} ) \\ {c}_{k} = {f}_{k} ⊗ {c}_{k} + {i}_{k} ⊗ tanh ( {W}_{fc} * {\tilde{f}}_{k} + {W}_{h c} {h}_{k - 1} + {b}_{c} )\end{matrix} \qquad ( 10 )$$

iₖ, eₖ, oₖ and cₖ represent an input gate, a forgetting gate, an output gate and a unit state respectively. Information of each moment k is transmitted in a CLSTM computing unit, and different types of gates may selectively add new information to the unit state. \tilde{f}ₖ represents an input vector at the moment k, and hₖ₋₁ represents an output of a hidden layer at the moment k−1. W_{fi}, W_{fe}, W_{fo}, W_{fc}, Wₕᵢ, Wₕₑ, Wₕₒ, W_{hc}, bᵢ, bₑ, bₒ, b_{c} is a network parameter. σ(⋅) represents a Sigmoid activation function, and * and ⊗ represent a convolution operation and a Hamiltonian multiplication respectively.

An output of the CLSTM network is H=[\tilde{h}₁, . . . , \tilde{h}_{batch}]^{•}∈ [symbol] . kernel is the number of convolution kernels in the CLSTM, and \tilde{h}ᵢ∈ [symbol] , i=1, . . . , batch is an output of the hidden layer of the CLSTM.

\tilde{x} output by the fully connected layer is spliced to H output by the CLSTM adaptive encoding layer to obtain Z=[\tilde{z}₁, . . . , \tilde{z}_{batch}]^{•}∈ [symbol] \tilde{z}ᵢ=[\tilde{x}ᵢ,\tilde{h}ᵢ]^{•}. A splicing operation is a process of fusing EKF parameter estimation and a neural network method, extends an input feature space of the neural network, and may improve accuracy of predicting the model.

With reference to FIG. 2, a tensor Z=[\tilde{z}₁, . . . , \tilde{z}_{batch}]^{•}∈ [symbol] is input into the multi-head attention mechanism module 205C and the feedforward module 205D to extract advanced features related to the degradation process from the data. Assuming that a multi-head attention mechanism uses the fully connected layer 205A to linearly transform a certain matrix \tilde{z}ᵢ (which is abbreviated as \tilde{z} for convenience) in the input tensor Z∈ [symbol] , a query Q^{h}=\tilde{z}W_{q}^{h}∈ [symbol] , a key K^{h}==\tilde{z}Wₖ^{h}∈ [symbol] , and a value V^{h}=\tilde{z}Wᵥ^{h}∈ [symbol] , h=1, . . . , H may be obtained. W_{q}^{h}, Wₖ^{h}, W_{q}^{h}∈ [symbol] is a network parameter, H is the number of heads of the multi-head attention mechanism, and a dimension is dₖ=r/H. A single-head attention mechanism computes a dot product of all queries and keys, divides the dot product by a scaling factor \sqrt{dₖ}, and inputs a result into a softmax function to obtain a corresponding attention weight matrix A^{h} ∈ [symbol] :

$${A}^{h} = softmax ( \frac{{Q}^{h} {K}^{h T}}{\sqrt{{d}_{k}}} ) {V}^{h} \qquad ( 11 )$$

such that the multi-head attention mechanism outputs

Multihead=Concat(A¹, . . . ,A^{H})W^{o} (12)
Concat is a merge operation by column, and W^{o}∈ [symbol] is a network [symbol] parameter.

The input tensor Z∈ [symbol] is input into the multi-head attention mechanism module 205C to obtain Z_{A}=Multihead∈ [symbol] . The multi-head attention mechanism module 205C is connected to the feedforward module 205D in a residual manner, such that

$${\tilde{Z}}_{A} = LayerNorm ( {Z}_{A} + Z ) \qquad ( 13 )$$

LayerNorm represents a layer regularization operation, \tilde{Z}_{A} is an output of a residual connection manner, and is transmitted into the feedforward module 205D, and the feedforward module 205D consists of two fully connected layers, and may be specifically represented as

$${Z}_{FF} = ReLU ( 0 , {\tilde{Z}}_{A} {W}_{1} + {b}_{1} ) {W}_{2} + {b}_{2} \qquad ( 14 )$$

W₁, W₂, b₁, b₂ are all network parameters, ReLU is an activation function, and Z_{FF} is an output of the feedforward module 205D. In the same way, the feedforward module 205D is also connected to a next module in a residual manner, and therefore

$${\tilde{Z}}_{FF} = LayerNorm ( {Z}_{FF} + {\tilde{Z}}_{A} ) \qquad ( 15 )$$

\tilde{Z}_{FF} is a final output of the feedforward module 205D.

With reference to FIG. 2, the final output \tilde{Z}_{FF} of the feedforward module 205D is input into the fully connected regression layer 205E, which may be specifically represented as:

$$\hat{Y} = Sigmoid ( {W}_{reg} {\tilde{Z}}_{FF} + {b}_{r e g} ) \qquad ( 16 )$$

W_{reg}, b_{reg} are both network parameters, Sigmoid is an activation function, and the obtained output is a predicted RUL value Ŷ=[ŷ₁, . . . , ŷ_{batch}]^{•}∈ [symbol] corresponding to the input {F, X}. The obtained predicted value uses a root-mean-square loss function to compute a loss value L:

$$L = min {\sum }_{i = 1}^{b a t c h} {\vert \hat{y} - \tilde{y} \vert}^{2} \qquad ( 17 )$$

Network training uses an Adam algorithm to update the parameters of the whole neural network

Step 6, use the neural network training data set to train and test the hybrid driven prediction model, to obtain a trained hybrid driven prediction model

A batch of data {F, X, Y} is randomly selected from the neural network training data set

$${D}^{( i )} = {\{ {\tilde{f}}_{k}^{( i )} , {x}_{k}^{( i )} , {\tilde{y}}_{k}^{( i )} \}}_{k = 0}^{{n}_{i} - 3 - t} , i = 1 , … , l - 1 , l + 1 , … , Q$$

obtained in step 4 to train the hybrid driven prediction model. In a training process, the neural network parameters are continuously updated until a training period reaches a maximum training period limit. An effect of the network model is verified on the test set

$${\{ {\tilde{f}}_{k}^{( l )} , {x}_{k}^{( l )} , {\tilde{y}}_{k}^{( l )} \}}_{k = 0}^{{n}_{l} - 3 - {t}_{l}} ,$$

and the neural network model having an optimal effect on the test set is retained as the trained hybrid driven prediction model N.

Step 7, use the trained hybrid driven prediction model to predict the RUL of the mechanical component.

When there are new sensor data sₖ*, sₖ₊₁* and sₖ₊₂* to arrive at a moment k+2, a variance feature varₖ* at the moment k is extracted, and then the optimal state estimate xₖ* is obtained by means of the EKF. Then, a frequency domain vector \tilde{f}ₖ*=[fₖ*, fₖ₊₁*, fₖ₊₂*]^{•} is constructed by means of the FFT. The vectors xₖ* and \tilde{f}ₖ*are simultaneously input into the trained hybrid driven prediction model N. That is, the predicted RUL ŷ* may be obtained.

The present disclosure provides a hybrid data- and model-driven method for predicting RUL of a mechanical component. In combination with the calibrated exponential random model and a multi-head attention neural network structure, the constructed hybrid driven prediction model may accurately predict the RUL in combination with the advantages of the data-driven method and the model-based method.

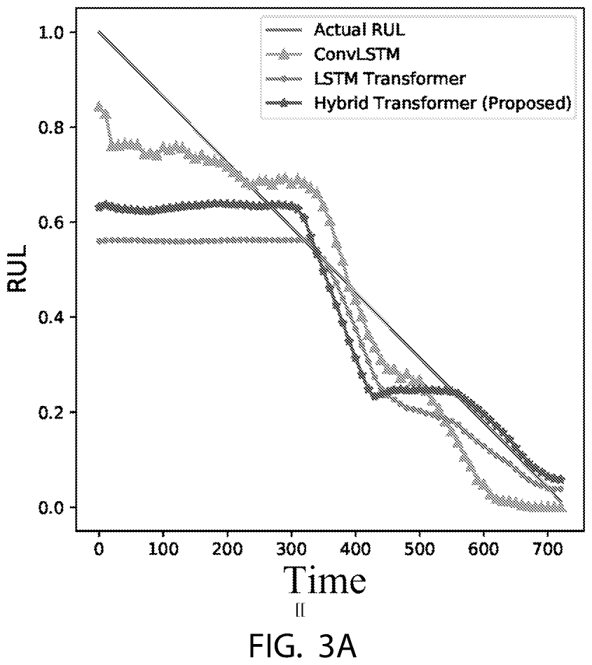

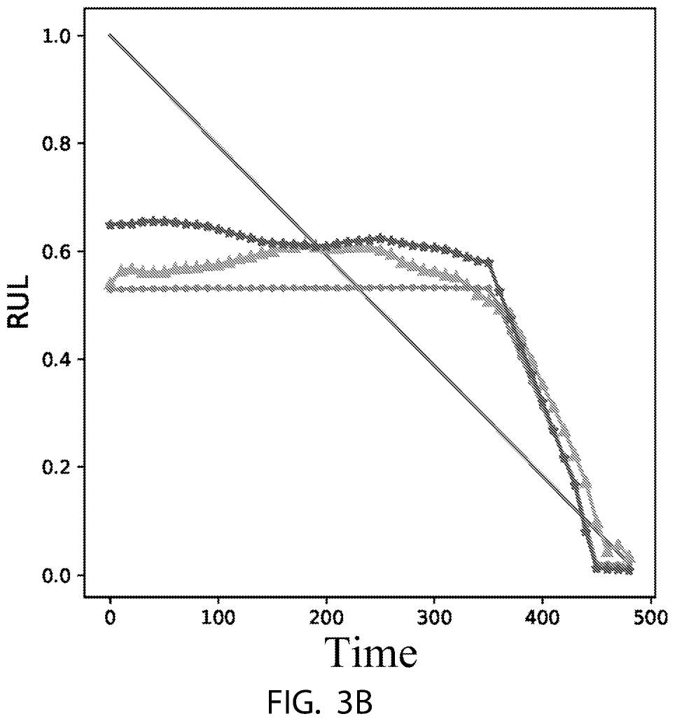

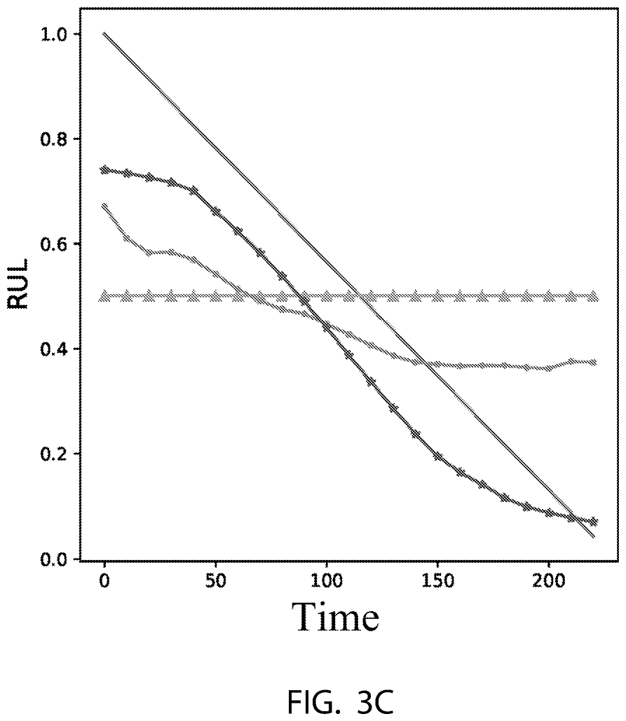

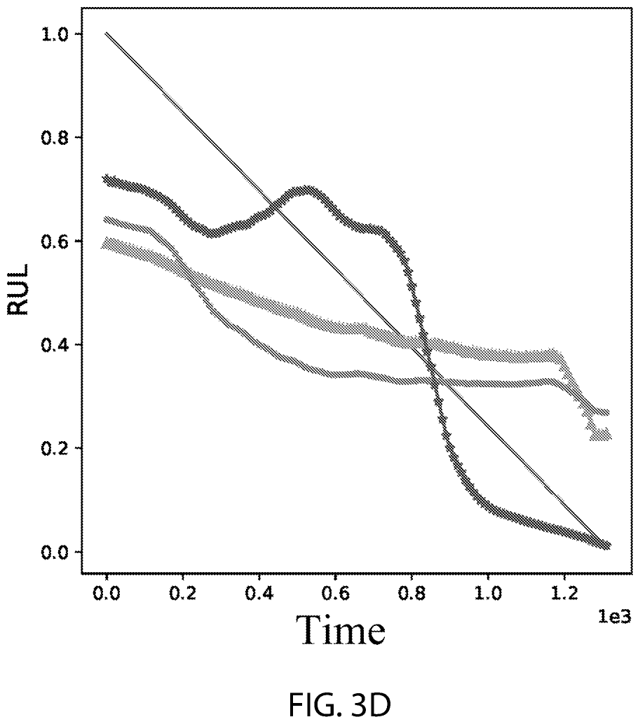

FIGS. 3A-D are diagrams of an operation effect of an example of a hybrid data- and model-driven method for predicting RUL of a mechanical component according to the present disclosure on an FEMTO bearing data set. The FEMTO bearing data set (i.e., state monitoring data set) consists of data collected from a PRONOSTIA platform, and includes vibration signals monitored by sensors in both a horizontal direction and a vertical direction. The data set includes three operation conditions. The conditions have different speeds and loads. In the embodiment, the number epoch of iterations of a training process is 120, a batch size of samples extracted each time is 16, and a learning rate 1 is 0.0002. The hybrid driven prediction model includes a fully connected layer, a one-dimensional convolutional long short-term memory network adaptive encoding layer, a multi-head attention mechanism module, a feedforward module, and a fully connected regression layer. In the diagram of the operation effect, a true value of the RUL of the mechanical component is represented as actual RUL. The hybrid data- and model-driven method for predicting RUL of a mechanical component (which is represented by hybrid transformer [proposed] in FIGS. 3A-D) according to the present disclosure is compared with other two methods (ConvLSTM and LSTM transformer). Intuitively, a prediction effect of the method of the present disclosure is closer to the true value, more accurate and superior to other two models.

As shown in Table 1, in terms of evaluation indicators, a root mean square error (RMSE), a mean absolute error (MAE) and a mean absolute percentage error (MAPE) of the three methods on a test set are compared.

TABLE 1

| | Method of the present disclosure | | | | | | | | |
|---|---|---|---|---|---|---|---|---|---|
| | Hybrid transformer | | | LSTM Transformer | | | ConvLSTM | | |
| | RMSE | MAE | MAPE | RMSE | MAE | MAPE | RMSE | MAE | MAPE |
| Bearing 2_1 | 0.1167 | 0.0956 | 0.3442 | 0.1688 | 0.1247 | 0.2735 | 0.1317 | 0.0959 | 0.2765 |
| Bearing 2_4 | 0.1795 | 0.1514 | 0.4711 | 0.2192 | 0.1789 | 0.5102 | 0.2119 | 0.1809 | 0.6025 |
| Bearing 3_1 | 0.0432 | 0.0362 | 0.1841 | 0.1950 | 0.1650 | 0.8611 | 0.2795 | 0.2410 | 1.2703 |
| Bearing 3_3 | 0.1366 | 0.1200 | 0.3197 | 0.2219 | 0.1996 | 1.1808 | 0.2129 | 0.1864 | 1.1104 |

From data in Table 1, it may be seen that the method of the present disclosure has three error indicators lower than those of other two methods, thereby reflecting the advantages of the hybrid data- and model-driven method for predicting RUL of a mechanical component according to the present disclosure on accuracy of the trained model.

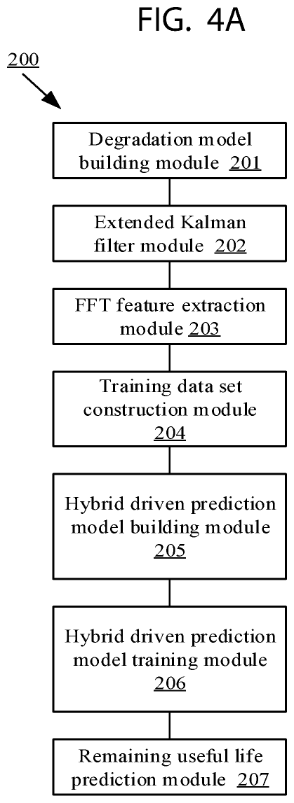

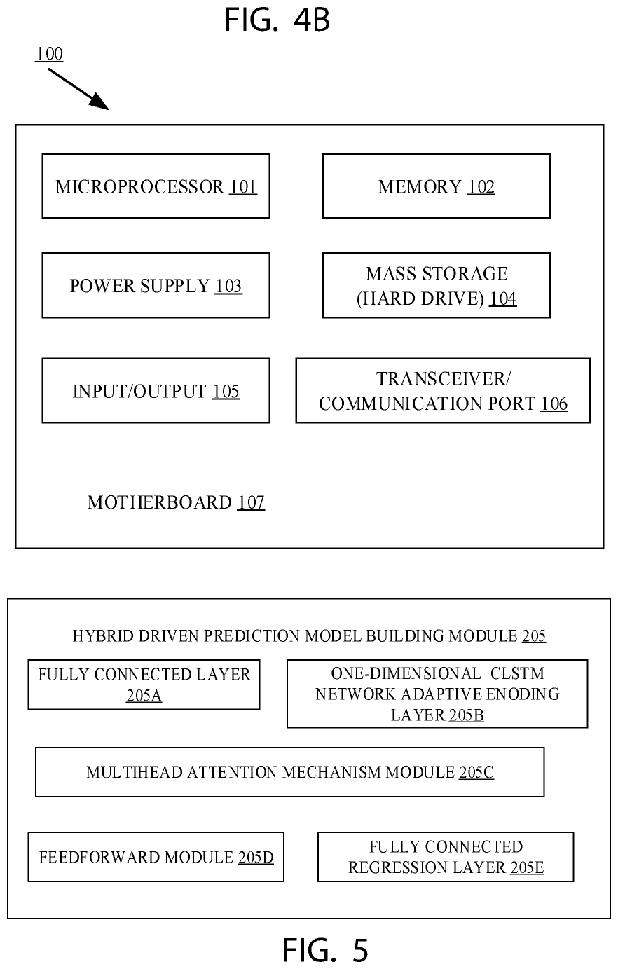

On the basis of the method according to the present disclosure, the present disclosure further provides a hybrid data- and model-driven system for predicting RUL of a mechanical component, as shown in FIG. 4A. The system includes:
a degradation model building module 201 for using an exponential random model to model a degradation process of the mechanical component and establish a system state space equation;
an EKF module 202 for estimating, on the basis of the system state space equation, parameters of the exponential random model by means of an EKF, to obtain an optimal state estimate;
an FFT feature extraction module 203 for obtaining state monitoring data in a degradation stage of the mechanical component on the basis of FPT, and using an FFT to obtain frequency domain data corresponding to the state monitoring data of the degradation stage;
a training data set construction module 204 for constructing a neural network training data set of all mechanical components according to the optimal state estimate and the frequency domain data;
a hybrid driven prediction model building module 205 for building a hybrid driven prediction model including a fully connected layer 205A, a one-dimensional convolutional long short-term memory network adaptive encoding layer 205B, a multi-head attention mechanism module 205C, a feedforward module 205D and a fully connected regression layer 205E, and FIG. 5 shows the specific structure of the hybrid driven prediction model building module 205;
a hybrid driven prediction model training module 206 for using the neural network training data set to train and test the hybrid driven prediction model, to obtain a trained hybrid driven prediction model; and
a RUL prediction module 207 for using the trained hybrid driven prediction model to predict the RUL of the mechanical component.

In addition, the system according to the embodiments of the present disclosure can also be implemented by means of an architecture of a computing device shown in FIG. 4B. Each module of the system can be implemented as the computing device, i.e., the motherboard 107, as shown in FIG. 4B. As shown in FIG. 4B, the computing device includes a microprocessor 101, a memory 102 (RAM/ROM), a power supply 103, a mass storage 104 or hard drive, input/output ports 105 and a transceiver 106. The mass storage 104 stores instructions implementing the embodiments of the present disclosure, and feeds the instructions to the microprocessor 101 via the memory 102. The microprocessor 101 executes the instructions to implement the embodiments of the disclosure. The input/output ports 105 can be for items such as a keyboard and/or mouse etc. The transceiver 106 can be useful for communication such as a NIC (network interface card) or wireless communication card. This communication port allows each module to communicate with other modules. The architecture shown in FIG. 4B is only exemplary, and when different devices are implemented, one or more components of the computing device shown in FIG. 4B can be reduced, or one or more additional components can be added into the computing device shown in FIG. 4B.

Further, the present disclosure further provides an electronic device. The electronic device may include: a processor, a communication interface, a memory and a communication bus. The processor, the communication interface and the memory communicate with one another by means of the communication bus. The processor may call a computer program in the memory, so as to execute the hybrid data- and model-driven method for predicting RUL of a mechanical component.

In addition, the computer program in the above memory may be stored in a computer-readable storage medium when the computer program is implemented in a form of a software function unit and is sold or used as an independent product. On the basis of such understanding, the technical solutions of the present disclosure essentially or the part contributing to the prior art may be embodied in a form of a software product. The computer software product is stored in a storage medium, and includes several instructions for enabling a computer device (which may be a personal computer, a server, a network device, etc.) to execute all or some steps of the methods described in the embodiments of the present disclosure. The above storage medium includes any medium that may store program codes, such as a USB flash drive, a removable hard disk, a read-only memory, a random access memory, a magnetic disk and an optical disc.

Further, the present disclosure further provides a non-transient computer-readable storage medium, storing a computer program. The computer program may implement the hybrid data- and model-driven method for predicting RUL of a mechanical component when executed.

The present disclosure provides the hybrid data- and model-driven method for predicting RUL of a mechanical component, which accurately predicts the RUL in combination with the calibrated exponential random model and a multi-head attention neural network structure. The method calibrates the parameters of the exponential random model by means of the EKF, and iteratively learns a value of an exponential function and the parameters of the exponential model; the method builds the prediction model in combination with a neural network module based on the multi-head attention mechanism, automatically learns input embedded position information by means of the adaptive positional encoding layer, and then models a mapping relation between the input data and the RUL by means of the multi-head attention mechanism; and therefore the method retains both accuracy of a model-driven method and a generalization capability of a data-based method, may greatly improve accuracy of predicting the RUL, has great significance for use of the hybrid data- and model-driven method in the field of intelligent manufacturing and health management of mechanical apparatuses, and has a wide application prospect.

Each embodiment of the present specification is described in a progressive manner, each embodiment focuses on the difference from other embodiments, and the same and similar parts between the embodiments may refer to each other. Since the system disclosed in an embodiment corresponds to the method disclosed in another embodiment, the description is relatively simple, and reference can be made to the method description.

Specific examples are used herein to explain the principles and implementations of the present disclosure. The foregoing description of the embodiments is merely intended to help understand the method and the core ideas of the present disclosure; and besides, various modifications can be made by those of ordinary skill in the art to specific implementations and the scope of application in accordance with the ideas of the present disclosure. In conclusion, the content of the present specification shall not be construed as limitations to the present disclosure.

1. A hybrid data- and model-driven method for predicting remaining useful life of a mechanical component, comprising:
using an exponential random model to model a degradation process of the mechanical component and establish a system state space equation;
estimating, on the basis of the system state space equation, parameters of the exponential random model by means of an extended Kalman filter, to obtain an optimal state estimate;
obtaining state monitoring data in a degradation stage of the mechanical component on the basis of first predicting time, and using fast Fourier transform (FFT) to obtain frequency domain data corresponding to the state monitoring data in the degradation stage;
constructing a neural network training data set of all mechanical components according to the optimal state estimate and the frequency domain data;
building a hybrid driven prediction model comprising a fully connected layer, a one-dimensional convolutional long short-term memory network adaptive encoding layer, a multi-head attention mechanism module, a feedforward module and a fully connected regression layer;
using the neural network training data set to train and test the hybrid driven prediction model, to obtain a trained hybrid driven prediction model; and
using the trained hybrid driven prediction model to predict the remaining useful life of the mechanical component.

2. The hybrid data- and model-driven method for predicting remaining useful life of a mechanical component according to claim 1, wherein the using an exponential random model to model a degradation process of the mechanical component and establish a system state space equation specifically comprises:
using the exponential random model
$${a}_{k} {e}^{{b}_{k}}$$
to model the degradation process of the mechanical component, aₖ, bₖ being a parameter related to a health state of the mechanical component in the degradation process; and
building the system state space equation
$$\{ \begin{matrix}{x}_{k} = f ( {x}_{k - 1} , {u}_{k - 1} ) + {w}_{k - 1} \\ {z}_{k} = h ( {x}_{k} ) + {v}_{k}\end{matrix}$$
on the basis of the exponential random model
$${a}_{k} {e}^{{b}_{k}} ,$$
a state vector at a moment k being
$${x}_{k} = {[ \begin{matrix}{a}_{k} {e}^{{b}_{k}} & {a}_{k} & {b}_{k}\end{matrix} ]}^{\cdot } ,$$
ƒ and h being nonlinear functions, xₖ₋₁ being a state vector at a moment k−1, uₖ₋₁ being a system input at the moment k−1, wₖ₋₁ being a random zero mean error at the moment k−1, zₖ being a measured value at the moment k, and vₖ being a measurement error at the moment k.

3. The hybrid data- and model-driven method for predicting remaining useful life of a mechanical component according to claim 2, wherein the estimating, on the basis of the system state space equation, parameters of the exponential random model by means of an extended Kalman filter, to obtain an optimal state estimate specifically comprises:
locally linearizing, on the basis of the system state space equation, the nonlinear functions ƒₖ and hₖ at the moment k about a state prior estimate \hat{x}ₖ, to obtain corresponding Jacobian matrices Fₖ and Hₖ;
building a prediction and update equation of an extended Kalman filter according to the Jacobian matrices Fₖ and Hₖ; and
alternately executing, on the basis of the prediction and update equation, a prediction and update process of the extended Kalman filter to continuously update a predicted state vector, so as to obtain the optimal state estimate.

4. The hybrid data- and model-driven method for predicting remaining useful life of a mechanical component according to claim 3, wherein the obtaining state monitoring data in a degradation stage of the mechanical component on the basis of first predicting time, and using fast Fourier transform (FFT) to obtain frequency domain data corresponding to the state monitoring data in the degradation stage specifically comprises:
determining the first predicting time on the basis of original state monitoring data of the mechanical component collected by a sensor;
extracting the state monitoring data in the degradation stage of the mechanical component on the basis of the first predicting time; and
using the FFT to extract frequency domain information of the state monitoring data in the degradation stage, to obtain the frequency domain data in the degradation stage.

5. The hybrid data- and model-driven method for predicting remaining useful life of a mechanical component according to claim 4, wherein the constructing a neural network training data set of all mechanical components according to the optimal state estimate and the frequency domain data specifically comprises:
constructing the neural network training data set
$${D}^{( i )} = {\{ ( {\tilde{f}}_{k}^{( i )} , {x}_{k}^{( i )} , {\tilde{y}}_{k}^{( i )} ) \}}_{k = 0}^{{n}_{i} - 3 - {t}_{i}} , i = 1 , … , Q$$
of all the mechanical components according to the optimal state estimate {xₖ⁽ⁱ⁾}ₖ₌₀ⁿ^{ᵢ}^{-3-t}^{ᵢ} and the frequency domain data {\tilde{f}ₖ⁽ⁱ⁾}ₖ₌₀ⁿ^{ᵢ}^{-3-t}^{ᵢ} in the degradation stage of the mechanical component, a moment tᵢ being the first predicting time, nᵢ being a length of a variance feature sequence, [symbol] being the number of the mechanical components i, and \tilde{y}ₖ⁽ⁱ⁾ being the remaining useful life of the mechanical component i at the moment k.

6. A hybrid data- and model-driven system for predicting remaining useful life of a mechanical component, comprising:
a degradation model building module for using an exponential random model to model a degradation process of the mechanical component and establish a system state space equation;
an extended Kalman filter module for estimating, on the basis of the system state space equation, parameters of the exponential random model by means of an extended Kalman filter, to obtain an optimal state estimate;
an FFT feature extraction module for obtaining state monitoring data in a degradation stage of the mechanical component on the basis of first predicting time, and using an FFT to obtain frequency domain data corresponding to the state monitoring data in the degradation stage;
a training data set construction module for constructing a neural network training data set of all mechanical components according to the optimal state estimate and the frequency domain data;
a hybrid driven prediction model building module for building a hybrid driven prediction model comprising a fully connected layer, a one-dimensional convolutional long short-term memory network adaptive encoding layer, a multi-head attention mechanism module, a feedforward module and a fully connected regression layer;
a hybrid driven prediction model training module for using the neural network training data set to train and test the hybrid driven prediction model, to obtain a trained hybrid driven prediction model; and
a remaining useful life prediction module for using the trained hybrid driven prediction model to predict the remaining useful life of the mechanical component.

7. An electronic device, comprising a memory, a processor and a computer program stored in the memory and runnable on the processor, wherein the processor implements the hybrid data- and model-driven method for predicting remaining useful life of a mechanical component of claim 1 when executing the computer program.

8. (canceled)

9. The electronic device according to claim 7, wherein the using an exponential random model to model a degradation process of the mechanical component and establish a system state space equation specifically comprises:
using the exponential random model
$${a}_{k} {e}^{{b}_{k}}$$
to model the degradation process of the mechanical component, aₖ, bₖ being a parameter related to a health state of the mechanical component in the degradation process; and
building the system state space equation
$$\{ \begin{matrix}{x}_{k} = f ( {x}_{k - 1} , {u}_{k - 1} ) + {w}_{k - 1} \\ {z}_{k} = h ( {x}_{k} ) + {v}_{k}\end{matrix}$$
on the basis of the exponential random model
$${a}_{k} {e}^{{b}_{k}} ,$$
a state vector at a moment k being
$${x}_{k} = {[ \begin{matrix}{a}_{k} {e}^{{b}_{k}} & {a}_{k} & {b}_{k}\end{matrix} ]}^{\cdot } ,$$
ƒ and h being nonlinear functions, xₖ₋₁ being a state vector at a moment k−1, uₖ₋₁ being a system input at the moment k−1, wₖ₋₁ being a random zero mean error at the moment k−1, zₖ being a measured value at the moment k, and vₖ being a measurement error at the moment k.

10. The electronic device according to claim 9, wherein the estimating, on the basis of the system state space equation, parameters of the exponential random model by means of an extended Kalman filter, to obtain an optimal state estimate specifically comprises:
locally linearizing, on the basis of the system state space equation, the nonlinear functions ƒₖ and hₖ at the moment k about a state prior estimate \hat{x}ₖ, to obtain corresponding Jacobian matrices Fₖ and Hₖ;
building a prediction and update equation of an extended Kalman filter according to the Jacobian matrices Fₖ and Hₖ; and
alternately executing, on the basis of the prediction and update equation, a prediction and update process of the extended Kalman filter to continuously update a predicted state vector, so as to obtain the optimal state estimate.

11. The electronic device according to claim 10, wherein the obtaining state monitoring data in a degradation stage of the mechanical component on the basis of first predicting time, and using fast Fourier transform (FFT) to obtain frequency domain data corresponding to the state monitoring data in the degradation stage specifically comprises:
determining the first predicting time on the basis of original state monitoring data of the mechanical component collected by a sensor;
extracting the state monitoring data in the degradation stage of the mechanical component on the basis of the first predicting time; and
using the FFT to extract frequency domain information of the state monitoring data in the degradation stage, to obtain the frequency domain data in the degradation stage.

12. The electronic device according to claim 11, wherein the constructing a neural network training data set of all mechanical components according to the optimal state estimate and the frequency domain data specifically comprises:
constructing the neural network training data set
$${D}^{( i )} = {\{ ( {\tilde{f}}_{k}^{( i )} , {x}_{k}^{( i )} , {\tilde{y}}_{k}^{( i )} ) \}}_{k = 0}^{{n}_{i} - 3 - {t}_{i}} , i = 1 , … , Q$$
of all the mechanical components according to the optimal state estimate {xₖ⁽ⁱ⁾}ₖ₌₀ⁿ^{ᵢ}^{-3-t}^{ᵢ} and the frequency domain data {\tilde{f}ₖ⁽ⁱ⁾}ₖ₌₀ⁿ^{ᵢ}^{-3-t}^{ᵢ} in the degradation stage of the mechanical component, a moment tᵢ being the first predicting time, nᵢ being a length of a variance feature sequence, [symbol] being the number of the mechanical components i, and \tilde{y}ₖ⁽ⁱ⁾ being the remaining useful life of the mechanical component i at the moment k.
